(19) United States
(12) Patent Application Publication
(10) Pub. No.: US 2015/0379538 A1
(43) Pub. Date: Dec. 31, 2015

(54) TECHNIQUES FOR OVERINDEXING INSIGHTS FOR SCHOOLS

(71) Applicant: Linkedln Corporation, Mountain View, CA (US)

(72) Inventors: Zach Cain, Mountain View, CA (US); Navneet Kapur, Sunnyvale, CA (US); Gloria Lau, Los Altos, CA (US)

(73) Assignee: Linkedln Corporation, Mountain View, CA (US)

(21) Appl. No.: 14/610,069

(22) Filed: Jan. 30, 2015

Related U.S. Application Data
(60) Provisional application No. 62/018,879, filed on Jun. 30, 2014.

(51) Int. Cl. G06Q 30/02

(52) U.S. Cl. CPC G06Q 30/0205; G06Q 50/20

(57) ABSTRACT

A method can include receiving a request for content including an attribute for a school. The method can analyze a social graph to identify a first set of nodes representing members, which can connect to a first node representing a first school, the social graph can be represented by a graph data structure having nodes representing various entities and edges representing associations between entities. The method can analyze a social graph to identify a second set of nodes representing members, the second set of nodes representing members connecting to a second node representing a school. The method can generate a central tendency of a number of the first set of nodes representing members and a number of the second set of nodes representing members and using the central tendency and a number of the first set of nodes representing members, can determine an index number for the first school.

### CLAIM OF PRIORITY

This patent application claims the benefit of priority of U.S. Provisional Patent Application Ser. No. 62/018,879, titled “Techniques for Overindexing Insights for Schools,” filed on Jun. 30, 2014, which is hereby incorporated by reference herein in its entirety.

### BACKGROUND

Members of social networking services are frequently asked to provide a variety of personal and/or professional information. For instance, a member can fill out various fields of a member profile with personal information such as the member's name, address, contact information, age, gender, or interests. Professional information commonly includes the type of information one would typically include in a curriculum vitae or resume, such as, education history, employment history, job skills, professional organization membership, and the like.

As companies and schools begin to utilize social networking services, for example, by providing company profiles and school profiles, social networking services have become an excellent resource for students or potential students (i.e., those considering higher education). Potential students looking for a school want to find a school that will be a good fit and further their ultimate career goals. A potential student might turn to a social networking service to evaluate a particular school or compare a school to another school. Companies want to hire people that will succeed in their organizations. Companies often search social networking services for potential employees possessing skills or other characteristics that will allow the employees to succeed in the business. Schools want to appeal to students and make their students appealing to companies. One way schools can do this is by differentiating themselves from their peers. However, it is often difficult for potential students, companies, and schools to discover the differences among schools, candidates, companies, and skill-sets.

Some social networking services allows members (such as students), schools, and companies to make digital connections that represent real-world relationships. For example, a member might indicate that he or she attended a school, worked for a company, and now works for a different company. The member might also describe certain skills learned at the school or at the various companies. In one scenario, a member deciding what school to attend might wish to know what successful former students at a particular school have in common and how that differs from former students at other schools.

### BRIEF DESCRIPTION OF THE DRAWINGS

Some embodiments are illustrated by way of example and not limitation in the FIGs. of the accompanying drawings, in which:

FIG. 1 is a block diagram showing an example of various functional components of a social networking system with an insights module for use with a wide variety of applications, and specifically for determining a member profile attribute;

FIG. 2 is a flow diagram showing an example of a technique, such as a method, for determining a member profile attribute;

FIG. 3 is a user interface for use with a messaging application that implements a method for determining and presenting a member profile attribute in an example;

FIG. 4 is a portion of an example of a user interface for use with a messaging application that implements a technique for determining and presenting a member profile attribute; and

FIG. 5 is a block diagram of a machine in the form of a computing device within which a set of instructions, for causing the machine to perform any one or more of the methodologies discussed herein, can be executed in an example.

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

### DETAILED DESCRIPTION

The present disclosure describes methods, systems, and computer program products for providing information about a school to members of a social networking service that allows those members to make informed decisions about the school. For example, the system can present the members with information on what skills other members associated with the school possess. The system can determine schools which have a high number of graduates and/or current students which possess particular skills and then this information can be used by a member to determine whether the school aligns with their learning goals. The system can do this by identifying members of the social networking service that attended the school and skills possessed by those members. For example, the system can calculate an index score for a number of members that attended the school and compare the index score to an average for the skill among a group of schools. When the index score exceeds the average, the system can present the skill as an over-indexed skill for the school. A skill can include a member profile attribute of a member, such as a member that attended a specified school.

In the following description, for purposes of explanation, numerous specific details are set forth in order to provide a thorough understanding of the various aspects of different examples. It will be evident, however, to one skilled in the art, that the examples can be practiced without all of the specific details or with variations, permutations, or combinations of the various features and elements described herein.

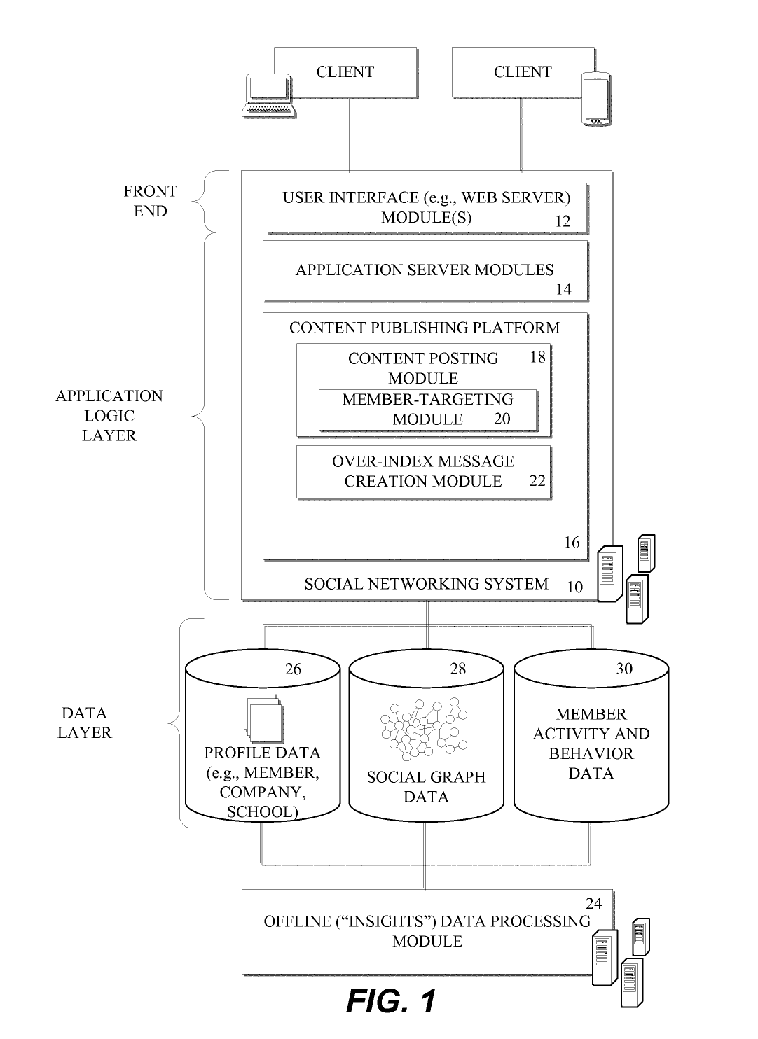

FIG. 1 is a block diagram illustrating an example of various functional modules or components of a social networking service. As shown in FIG. 1, the social networking system 10 is generally based on a three-tiered architecture, comprising a front-end layer, application logic layer, and data layer. As is understood by one of ordinary skill in the art, each module or engine shown in FIG. 1 represents a set of executable software instructions and the corresponding hardware (e.g., memory and processor) for executing the instructions. Various functional modules and engines that are not necessary to conveying an understanding of the subject matter have been omitted from FIG. 1. However, one of ordinary skill in the art will readily recognize that various additional functional modules and engines can be used with a social networking system, such as that illustrated in FIG. 1, to facilitate additional functionality that is not specifically described herein. Further, the various functional modules and engines depicted in FIG. 1 can reside on a single server computer, or can be distributed across several server computers in various arrangements. Moreover, although depicted in FIG. 1 as a three-tiered architecture, the system is not limited to such architecture.

As shown in FIG. 1, the front end can comprise a user interface module (e.g., a web server) 12, which can receive requests from various client-computing devices, and communicates appropriate responses to the requesting client devices. For example, the user interface module(s) 12 can receive requests in the form of Hypertext Transport Protocol (HTTP) requests, or other web-based, application programming interface (API) requests. The client devices (not shown) can be executing conventional web browser applications, or applications that have been developed for a specific platform to include any of a wide variety of mobile devices and operating systems.

The application logic layer includes various application server modules 14, which, in conjunction with the user interface module(s) 12, generates various user interfaces (e.g., web pages) with data retrieved from various data sources in the data layer. In an example, individual application server modules 14 are used to implement the functionality associated with various applications, services, or features of the social networking service. For example, a messaging application such as an email application, an instant messaging application, or some hybrid or variation of the two, can be implemented with one or more application server modules 14. Similarly, a search engine enabling members to search for and browse member profiles can be implemented with one or more application server modules 14.

As shown in FIG. 1, the data layer includes several databases, including profile data 26, social graph data 28, and member activity and behavior data 30. The profile data 26 can include member profile data (e.g., name, age, gender, interests, schools, skills, job title, job description, etc.), company profile data, educational institution profile data (school data), group data, or the like. The social graph data 28 can include graph structures with nodes, edges, and properties to represent data. A graph data structure can comprises nodes connected by edges. Each node in the graph data structure represents an entity in a social graph. For example entity types that exist in one implementation of a social graph can include a person, a company, an educational institution (e.g., college, school, or university), or a group (e.g., an online group, hosted by the social networking service, or some other third party server system, or a real-world organization, such as a professional organization) as nodes. Edges that connect any two nodes can represent a wide variety of different associations. For example, in general, an edge can represent a relationship, an affiliation, an activity or event, or some other affinity shared in common between two entities. In an example, a first node can represent a school and a second node can represent a member. An edge between the school and the member can represent that the member attended the school, graduated from the school, is following the school, will attend the school in the future, or the like. The member activity and behavior data 30 can include information about member actions such as page views, profile views, communications (e.g., postings, emails, blog posts, and the like), or just about any other similar type of action a member can take. In an example, the user interface 12 can be displayed on a client, such as a computer or a phone. In an example, a school can include a university, a community college, a high school, a place for higher learning, or the like.

In an example, an offline (“insights”) data processing module (insights module) 24 of FIG. 1, can be used with the over-index message creation module 22. The insights module 24 can be used with a wide variety of applications and specifically for identifying, and then presenting, over-indexed member profile attributes of members who attended or graduated from a particular school. In another example, not shown, the insights module can be a part of the content publishing platform 16 and can be run online. Other applications or services that utilize the insights module 24 can be separately embodied in their own application server modules and content publishing platforms. The over-index message creation module 22 can allow an authorized member of a school to create or edit a message describing an over-indexed skill associated with the school or allow a message with an over-indexed skill to be posted to a school news feed using the content publishing platform 16. The content posting module 18 can include a member-targeting module 20 to allow a member to specify a target audience by selecting desirable member attributes or characteristics possessed by those members to be included in the target audience, such as followers of a school, etc. In an example, an authorized member of a specified school can use the member-targeting module 20 and the over-index message creation module 22 to create a message about an over-indexed skill for the specified school and send the message to a select group of members, such as members who follow the specified school, members who visited the specified school's website or social networking services page, members who are graduates of the specified school, members who attended the specified school, members who have expressed interest in the specified school, or the like.

In addition to the over-index message creation module 22, the content publishing platform 16 can include a content posting module 18. The content posting module 18 can operate with a user interface or an application programming interface (API) to enable a member or application to specify content to be published and presented to other members. For example, the content posting module 18 can have an associated user interface for members to generate or arrange content to be included in a content posting. The content posting module 18 can allow a member to post information about an over-indexed skill for a school. The member-specified content can include text, file attachments (e.g., photographs, documents, audio or video files, etc.), hyperlinks, or the like.

The insights module 24 can be implemented as a service that operates by using information from the data layer, such as from member profile data 26, social graph data 28, or member activity and behavior data 30. In an example, the insights module 24 can facilitate the viewing of member, company, school, or group profiles. The insights module 24 can operate offline or in a separate system from the social networking system 10. For example, the insights module 24 can be on multiple servers, such as Hadoop servers for processing data. The insights module 24 can do data processing according to a schedule or automatically, or on demand.

The insights module 24 can access information related to schools, companies, skills, or other attributes. In an example, the insights module 24 can access information about a member, such as the company the member works for, the member's job title, the school the member attended, or skills the person possesses. The insights module 24 can access or receive this data from profile data, such as a member profile. In an example, the insights module 24 can return an output to the user interface, such as by sending information to a network update stream, a news feed, a user interface, a content stream, or an activity stream. A network update stream can include a series of sets of information displayed for a member. The output from the insights module 24 can include information about a school, a company, a skill, or a member. A network update stream can include a school profile news feed or a member news feed. For example, the insights module 24 can present information on a school profile or on a news feed of a member.

In an example, the insights module 24 can use the techniques described below on a specified set of schools. For example, the technique can be used to determine one or more schools that are over-indexed for a specified member profile attribute. In an example, the insights module 24 can repeat the technique for schools other than the specified school and for other member profile attributes. The insights module 24 can use the technique with a specified member profile attribute (e.g., a skill), a specified school, a specified member profile attribute and a specified school, or a specified set of schools, such as geographically close schools, schools with common majors, schools in common conferences, or any other specified combination of schools.

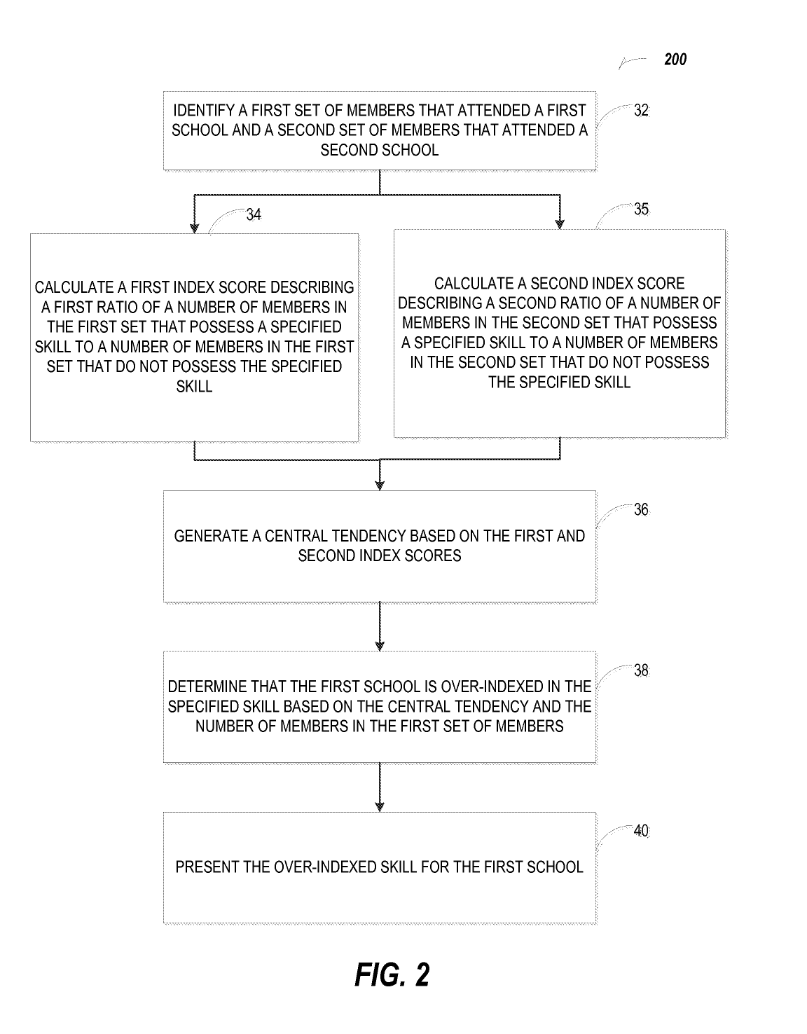

FIG. 2 is a flow diagram showing an example of a technique 200, such as a method, for determining a member profile attribute. The technique 200 can include an operation 32 to identify a first set of members that attended a first school and a second set of members that attended a second school. In an example, the technique 200 can be used with members who graduated from, or attended, a specified school, such as a school specified by a member in a request for over-indexed skills for the specified school. For example, a member can request to receive information on all over-indexed skills for a specified school. In another example, a member can request to receive information on all schools that have a specified over-indexed skill. The technique 200 can include members who graduated from the specified school within a certain amount of time, such as recent graduates (e.g., within the last five years, the last year, etc.), or graduates from a specified year or decade (e.g., all graduates from 2006). The technique can include members who work in a certain geographic location, such as a country, an area of a country, a state, a city, etc. (e.g., Canada, the east coast, Minnesota, Chicago, Brooklyn, the Dakotas, etc.). In an example, the technique can include members with a certain first job title, a certain first company, or a certain current company.

The technique 200 can include an operation 34 to calculate a first index score describing a first ratio of a number of members in the first set that possess a specified skill to a number of members in the first set that do not possess the specified skill. The technique can include an operation 35 to calculate a second index score describing a second ratio of a number of members in the second set that possess a specified skill to a number of members in the second set that do not possess the specified skill. The technique can include determining information about members connected to a specified school, such as a skill. The skill can include a member profile attribute. The technique can determine members that possess the particular member profile attribute and the members that do not possess the particular member profile attribute, and can calculate a ratio of members. From the ratio, an index score can be determined for the specified school for the particular member profile attribute (e.g., skill)

In an example, the technique can be repeated for schools other than the specified school. For example, the technique can be done for a second school other than the specified school. The technique can use the index score determined for the specified school and for the other school to determine a central tendency, such as a median or average. The technique 200 can include an operation 36 to generate a central tendency based on the first and second index scores. The technique 200 can determine whether the index score for the specified school is greater than the central tendency. If the index score for the specified school is greater than the central tendency, the specified school can be considered over-indexed for the particular member profile attribute of the technique. For example, the technique 200 can include an operation 38 to determine that the first school is over-indexed in the specified skill based on the central tendency and the number of members in the first set of members. In an example, the specified school can be considered over-indexed for the particular member profile attribute of the technique if the index score for the specified school exceeds a threshold, such as when the index score is greater than a standard deviation above a central tendency.

In an example, the over-indexed skill can include being determined by a standard score. A central tendency, such as a mean can be determined using the number of members having a skill for a set of schools. A standard deviation can be determined for the skill using the number of members having the skill for the set of schools and the mean. A standard score can be determined for a specified school by using the mean for the set of schools and the standard deviation of the specified school. For example, put another way, the mean can represent the average fraction of graduates having a skill across all schools in a group. The standard deviation can be the fraction of graduates having that skill across all schools in the group. The standard score can be determined by subtracting the mean from the number of members having a particular skill for a specified school and then dividing by the standard deviation. The standard score can be called a z-value, z-score, normal score, or the like. The standard score can allow for comparisons to be made across different skills with different means or standard deviations to show how much a specified school is over-indexed in a particular skill compared to another school and another skill. In a particular example, fractions of graduates of schools A, B, C, D, and E for skill S1, can be 0.11, 0.12, 0.09, 0.02, and 0.105 respectively. The mean for these five schools would be 0.089 and the standard deviation would be 0.0401. Using the standard score method above, the standard score for school A for skill S1 would be (0.11−0.089)/(0.0401)=0.524. Therefore, the skill S1 would be overindexed for school A because 0.524>0.

In an example, a threshold can be used to determine if a school is over-indexed in a particular skill. For example, if the number of members for a specified school that have a skill is greater than a threshold then the specified school can be over-indexed in the skill. In some examples, the threshold can be the mean of the number of members for a set of schools that have the skill The threshold for the mean can include a raw number or a number of standard deviations, such as one. In another example, if the standard score for a specified school is greater than a threshold, then the specified school can be over-indexed in the skill. The threshold for over-indexing using a standard score can be a number, such as zero. A school can be over-indexed in a specified skill if the standard score exceeds a threshold, such as zero.

In an example, the technique can be repeated for the specified school for other member profile attributes. For each member profile attribute, the technique can also be repeated on a number of other schools. The index score for each school can be determined, and a central tendency for each member profile attribute can be determined. The technique can be repeated for the specified school for additional member profile attributes until a number of over-indexed member profile attributes is determined for the specified school, such as until a first over-indexed member profile attribute is determined.

The technique 200 can be used with any combination of a member or members, a school or schools, a member profile attribute or member profile attributes, or any other information that can be obtained, such as from profile data. The technique 200 can include an operation 40 to present the over-indexed skill for the first school.

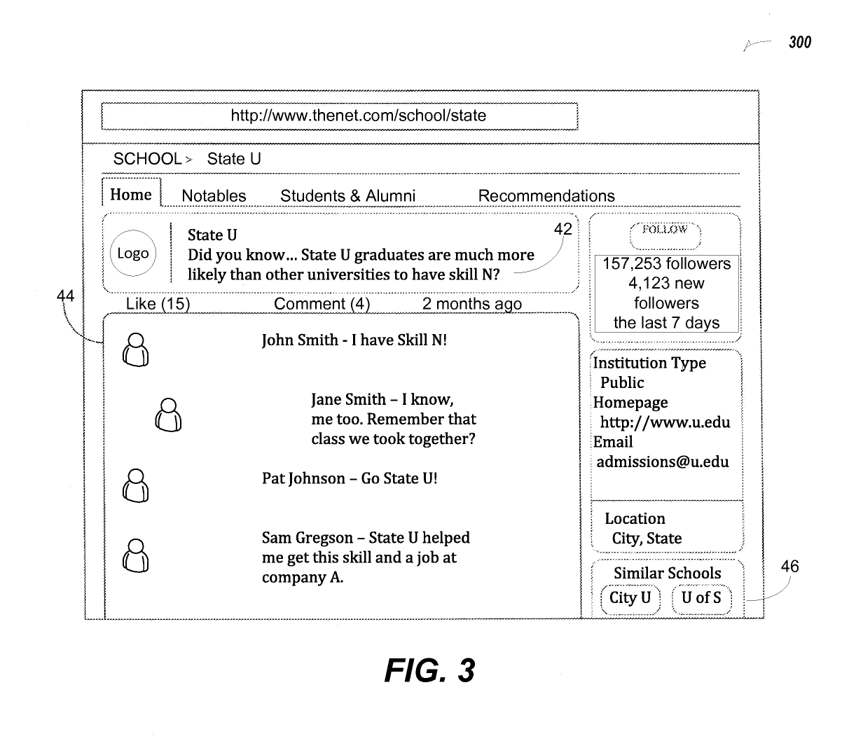

FIG. 3 is a user interface 300 of a messaging application that implements a method for determining and presenting an member profile attribute in an example. The messaging application can be used to display results from the insights module 24 from FIG. 1. The user interface 300 of FIG. 3 can be the user interface 12 from FIG. 1. In the example user interface 300 of FIG. 3, a network feed or network update stream is shown for a specified school, such as State U. In the user interface 300, an authorized member of the specified school can post a message 42 to convey information about over-indexing, such as by posting a message about a member profile attribute or, for example, skill N. In an example, the over-indexed skills can be determined according to a schedule, such as nightly or weekly.

In an example, a number of over-indexed skills for a particular school can be determined and stored in a school profile for the particular school, such as a list of the top ten over-indexed skills. The list can be hidden from members, though it is a part of the school profile data, or the list can be made visible. The over-indexed skills can be made available to an authorized member of a specified school, and the authorized member can post a message 42 in the school's news feed. The authorized member can also edit the message 42 or the message 42 can be compiled for the authorized member. In another example, the message 42 can be posted to a school's news feed automatically without any member interaction. The authorized member can be prompted to post the message 42 or a reminder can be sent to the authorized member to post the message 42. The authorized member can sign up to receive prompts or reminders or the prompts or reminders can be sent to the authorized member without a direct request from the authorized member.

In an example, the message 42 can be inserted into a member's news feed. For example, it can be determined that a member follows a school or has interest in a school, such as by a member selecting to follow the news feed of the school, selecting to receive information about the school, or visiting the school's website, page, or news feed. The message 42 can be inserted into the member's news feed after determining that the member is interested in the school. In another example, the message 42 can be sent directly to a member that is interested in a school. In an example, the user interface 300 can include a member interaction stream 44, such as a member comment field or a “like” option. In an example, the member interaction stream 44 can include comments from members related to the member profile attribute or skill N, the specified school, or any other information a member provides. In an example, the specified school can also interact with the members on the member interaction stream 44.

The user interface 300 can include a similar schools interface 46. The similar schools interface 46 can include identifying other schools, such as with a link to another school (e.g., City U or U of S). The other schools presented in the similar schools interface 46 can include schools that are over-indexed to the same member profile attribute as identified in the message 42 (e.g., skill N). The other schools presented in the similar schools interface 46 can also include schools that have one or more similarities to the specified school, such as geographic location, institution type, number of students, tuition, or any other similarities. The similar schools interface 46 can also include schools that are not over-indexed to the member profile attribute in the message 42.

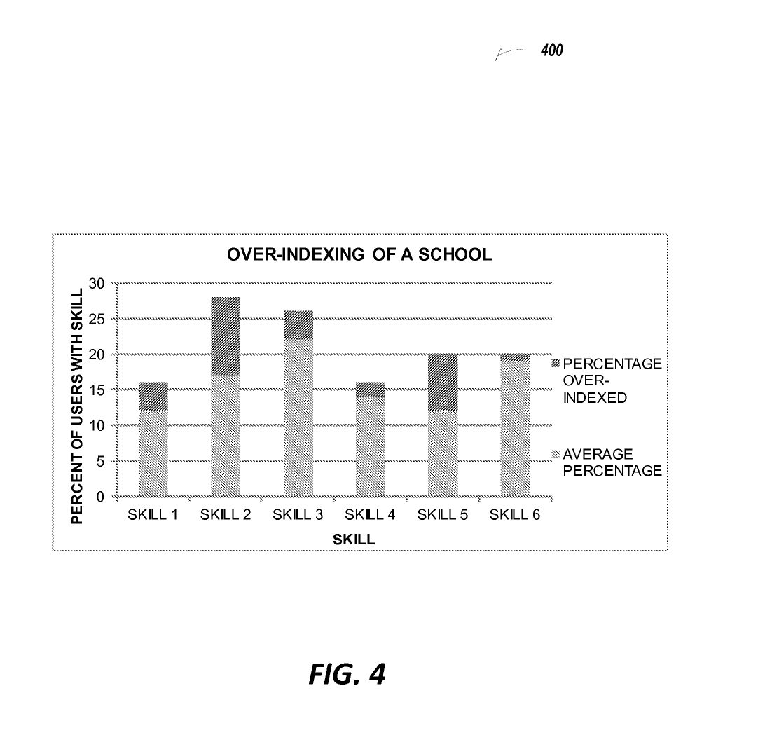

FIG. 4 is a portion of an example of a user interface for use with a messaging application that implements a technique for determining and presenting a member profile attribute. In an example, a graph 400 of FIG. 4 is a visual representation of member profile attributes or skills where a specified school is over-indexed in the member profile attribute or skill. For example, skill 1 can represent a member profile attribute of a school that is over-indexed. The bar above skill 1 in graph 400 has two sections, the bottom bar can be a central tendency of the index scores for a number of schools, and the top bar can be the amount over-indexed, above the bottom bar, of the index score for the specified school of graph 400. The bars work similarly for skills 2-6. The y-axis of graph 400 can show percentages of members that have a particular skill or member profile attribute. The graph 400 can visually show a number of skills so that a member can compare two or more over-indexed skills for a particular school. For example, skill 2 and skill 4 have similar central tendencies, but the specified skill has a significantly higher over-index for skill 2 compared to skill 4 In another example, a graph (not shown) can be used to show over-indexing scores of more than one school for one or more specified member profile attributes, which can allow a member to compare two or more schools based on their index score related to the specified member profile attribute or member profile attributes.

In an example, the portions marked “percentage over-indexed” in graph 400 can represent a percentage over-indexed score for the school and the portions marked “average percentage” can signify the average percentage of scores for the skill across the group of schools considered. For example, a school such as MIT can be compared to other U.S. schools. If the first skill (Skill 1) is JAVA, the portion marked “percentage over-indexed” for Skill 1 can be the percentage of MIT graduates who have JAVA listed on their profile. The portion marked “average percentage” for Skill 1 can then be the average of all percentages computed for every school in the U.S. for JAVA. In other words, each percentage can be the percentage of graduates from a U.S. school who are skilled in JAVA.

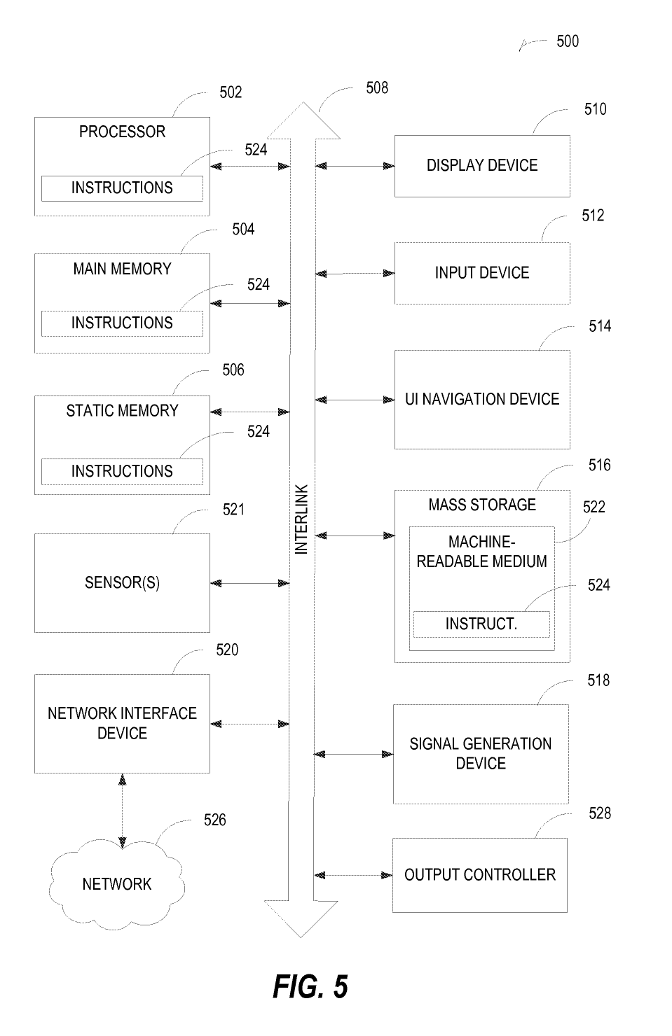

FIG. 5 illustrates a block diagram of an example machine 500 upon which any one or more of the techniques (e.g., methodologies) discussed herein can perform. In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include configurable execution units (e.g., transistors, circuits, etc.) and a computer readable medium containing instructions, where the instructions configure the execution units to carry out a specific operation when in operation. The configuring can occur under the direction of the executions units or a loading mechanism. Accordingly, the execution units are communicatively coupled to the computer readable medium when the device is operating. In this example, the execution units can be a member of more than one module. For example, under operation, the execution units can be configured by a first set of instructions to implement a first module at one point in time and reconfigured by a second set of instructions to implement a second module.

Machine (e.g., computer system) 500 can include a hardware processor 502 (e.g., a central processing unit (CPU), a graphics processing unit (GPU), a hardware processor core, or any combination thereof), a main memory 504 and a static memory 506, some or all of which can communicate with each other via an interlink (e.g., bus) 508. The machine 500 can further include a display unit 510, an alphanumeric input device 512 (e.g., a keyboard), and a user interface (UI) navigation device 514 (e.g., a mouse). In an example, the display unit 510, input device 512 and UI navigation device 514 can be a touch screen display. The machine 500 can additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 can include a machine readable medium 522 on which is stored one or more sets of data structures or instructions 524 (e.g., software) embodying or utilized by any one or more of the techniques or functions described herein. The instructions 524 can also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 can constitute machine readable media.

While the machine readable medium 522 is illustrated as a single medium, the term “machine readable medium” can include a single medium or multiple media (e.g., a centralized or distributed database, and/or associated caches and servers) configured to store the one or more instructions 524. The machine readable medium 522 can include a non-transitory machine readable medium.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples can include solid-state memories, and optical and magnetic media. Examples of machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 can further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Various Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
using one or more computer processors:
identifying a first set of members that attended a first school and a second set of members that attended a second school;
calculating a first index score describing a first ratio of a number of members in the first set that possess a specified skill to a number of members in the first set that do not possess the specified skill;
calculating a second index score describing a second ratio of a number of members in the second set that possess the specified skill to a number of members in the second set that do not possess the specified skill;
generating a central tendency based on the first and second index scores;
determining that the first school is over-indexed in the specified skill based on the central tendency and the number of members in the first set of members; and
presenting the over-indexed skill for the first school.

2. The method of claim 1, further comprising calculating a third index score describing a third ratio of a number of members in a third set of members that attended a third school that possess a specified skill to the number of members in the third set that do not possess the specified skill and wherein generating the central tendency includes generating the central tendency based on the first, second, and third index scores.

3. The method of claim 1, wherein using the central tendency and the number of the first set of members includes using a standard deviation to determine a standard score.

4. The method of claim 3, wherein the first school is over-indexed in the specified skill if the standard score exceeds a threshold.

5. The method of claim 4, wherein the threshold is zero.

6. The method of claim 1, further comprising, iterating the method to determine at least one other over-indexed skill for the first school.

7. The method of claim 1, wherein the central tendency is an average or a median.

8. The method of claim 1, wherein presenting the over-indexed skill for the first school includes presenting the over-indexed skill on a profile of the first school.

9. The method of claim 1, wherein presenting the over-indexed skill for the first school includes:
determining that a member follows the first school; and
presenting the over-indexed skill in a news feed of the member.

10. A system comprising:
at least one processor for executing instructions;
a memory device in communication with the at least one processor and storing instructions, which when executed by the at least one processor, cause the system to:
identify a first set of members that attended a first school and a second set of members that attended a second school;
calculate a first index score describing a first ratio of a number of members in the first set that possess a specified skill to a number of members in the first set that do not possess the specified skill;
calculate a second index score describing a second ratio of a number of members in the second set that possess the specified skill to a number of members in the second set that do not possess the specified skill;
generate a central tendency based on the first and second index scores;
determine that the first school is over-indexed in the specified skill based on the central tendency and the number of the first set of members; and
present the over-indexed skill for the first school.

11. The system of claim 10, further comprising calculate a third index score describing a third ratio of a number of members in a third set of members that attended a third school that possess a specified skill to the number of members in the third set that do not possess the specified skill and wherein to generate the central tendency includes to generate the central tendency based on the first, second, and third index scores.

12. The system of claim 10, wherein to determine that the first school is over-indexed in the specified skill includes to use the central tendency, the number of the first set of members, and a standard deviation to determine a standard score.

13. The system of claim 12, wherein the first school is over-indexed in the specified skill if the standard score exceeds a threshold and wherein the threshold is zero.

14. The system of claim 10, further comprising, determine at least one other over-indexed skill for the first school.

15. The system of claim 10, wherein the central tendency is an average or a median.

16. The system of claim 10, wherein to present the over-indexed skill for the first school includes to present the over-indexed skill on a profile of the first school.

17. The system of claim 10, wherein to present the over-indexed skill for the first school includes:
to determine that a member follows the first school; and
to present the over-indexed skill in a news feed of the member.

18. A machine-readable medium including instructions for receiving information that, when executed by a machine, cause the machine to perform operations comprising:
identifying a first set of members that attended a first school and a second set of members that attended a second school;
calculating a first index score describing a first ratio of a number of members in the first set that possess a specified skill to a number of members in the first set that do not possess the specified skill;
calculating a second index score describing a second ratio of a number of members in the second set that possess the specified skill to a number of members in the second set that do not possess the specified skill;
generating a central tendency based on the first and second index scores;
determining that the first school is over-indexed in the specified skill based on the central tendency and the number of members in the first set of members; and
presenting the over-indexed skill for the first school.

19. The machine-readable medium of claim 18, wherein using the central tendency and the number of the first set of members includes using a standard deviation to determine a standard score.

20. The machine-readable medium of claim 18, wherein the first school is over-indexed in the specified skill if the standard score exceeds a threshold.
